(19) United States
(12) Patent Application Publication
(10) Pub. No.: US 2011/0179850 A1
(43) Pub. Date: Jul. 28, 2011

(54) CALIBRATION METHOD AND OPERATING METHOD FOR A MOTION SENSOR, AND MOTION SENSOR

(76) Inventors: Roland KLINNERT, Korntal-Muenchingen (DE); Thorsten SOHNKE, Asperg (DE)

(21) Appl. No.: 12/846,140

(22) Filed: Jul. 29, 2010

(30) Foreign Application Priority Data
Jul. 29, 2009 (DE) 10 2009028072.3

(51) Int. Cl. G01C 25/00; G01P 21/00

(52) U.S. Cl. 73/1.37

(57) ABSTRACT

A calibration method is provided for a motion sensor, in particular a pedometer, a first acceleration signal being measured as a function of an acceleration parallel to a first direction in a first calibration step, a second acceleration signal being measured as a function of an acceleration parallel to a second direction in a second calibration step, and an acceleration vector being ascertained from the angle between the first and the second acceleration signal in a third calibration step, and a phase angle between the acceleration vector and the first direction being determined in a fourth calibration step for determining a calibration signal.

### RELATED APPLICATION INFORMATION

The present application claims priority to and the benefit of German patent application no. 10 2009 028 072.3, which was filed in Germany on Jul. 29, 2009, the disclosure of which is incorporated herein by reference.

### FIELD OF THE INVENTION

The present invention is based on an operating method according to the description herein.

### BACKGROUND INFORMATION

Methods of this kind and a pedometer are discussed for example in European Patent document EP 9 777 974 A1, in which the speed and the distance traveled may be inferred by way of a single acceleration sensor by integrating the acceleration signal. In this instance, the acceleration sensor is situated in the sole of a shoe. The speed is multiplied by a fixed calibration factor that is stored in the pedometer. A disadvantage of this pedometer is that on the one hand it requires a comparatively precise alignment of the sensor parallel to the direction of motion and that on the other hand the calibration factor is not adapted accordingly when there is a change in position of the sensor, for example when the user's foot is slightly out of position. The effort of aligning the acceleration sensor is therefore comparatively high and the precision of determining the speed is therefore comparatively low. Moreover, the steps are determined merely as a function of the amplitude of the acceleration signal, which only allows comparatively quick steps such as when jogging or running to be evaluated, while slower walking or shuffling cannot be detected in this manner due to insufficiently large amplitudes.

### SUMMARY OF THE INVENTION

The calibration method of the present invention, the operating method of the present invention and the motion sensor of the present invention as recited in the independent claims have the advantage over the related art that an automatic calibration of the motion sensor is performed, which detects the orientation of the motion sensor relative to a forward direction and in particular relative to the gravitational field while the motion sensor is in motion, i.e. in particular during a walking motion of the user of the motion sensor. This allows for a comparatively precise step detection without requiring a complex alignment of the motion sensor or a manual calibration.

In particular, the markedly increased precision compared to the related art advantageously makes it possible to use the motion sensor permanently in the area of medicine and nursing, in particular for old and chronically ill users such that for example movement patterns of the users may be recorded and analyzed. The calibration of the acceleration sensor may be continuously repeated such that a change of the alignment of the acceleration sensor in operation does not result in an impairment of the precision. The mentioned advantages are achieved by the fact that first the acceleration vector is determined as a function of the first and second acceleration signals, which results essentially from the difference between the first and second acceleration signals (for example by vector addition). Because of the constant hip rotation of the user in a walking motion (alternately setting down the left and the right foot of the user), the direction of the acceleration vector oscillates relative to the first (or alternatively the second) direction. Hence the phase angle between the first direction and the motion vector changes as a function of time and fluctuates continually around an essentially constant average value. This average value advantageously depends merely on the orientation of the motion sensor relative to the forward direction or on the position of the motion sensor relative to the user, the average value depending not at all or hardly on the speed of the forward motion.

Particularly, this average value may even correspond essentially to the angle between the forward direction and the first direction of the acceleration sensor in the horizontal plane. The evaluation of the phase angle is thus a measure for the orientation or the position of the motion sensor and is thus usable for determining the calibration signal for calibrating the acceleration signal, at least in a plane that is horizontal with respect to the gravitational field. For this purpose, the phase angle is compared for example with a reference signal, which is taken from a lookup table, for example. The coordinate system of the acceleration sensor is subsequently rotated as a function of the calibration signal, in particular virtually, in such a way that the calibrated first direction is aligned parallel to the forward direction and the calibrated second direction is aligned parallel to the transverse direction such that in the calibrated acceleration sensor the forward motion may be derived in the known manner directly from the calibrated first acceleration signal. For this purpose, the forward motion is measured for example by a frequency analysis of the first or second acceleration signal. Advantageous embodiments and developments of the present invention may be gathered from the dependent claims and the specification with reference to the drawing.

A development provides for the time average of the phase angle to be determined in the fourth calibration step for determining the calibration signal. In an advantageous manner, the determination of the calibrations signal thus becomes independent of the speed of the motion sensor, i.e. in particular of the gait of the user such as e.g. running, jogging, walking, ambling.

A development provides for the constant component in the phase angle to be determined in the fourth calibration step and to be removed in particular by a high-pass filter. The change of the phase angle is greatest at the reversal points of the hip rotation and is lowest around the average value. Consequently, a comparatively simple determination of the calibration signal or the forward direction is possible by extracting the constant component (i.e. the range around the average value of the phase angle) from the signal of the phase angle since this constant component depends directly on the orientation or the position of the acceleration sensor.

A development provides for measuring a third acceleration signal as a function of an acceleration parallel to a third direction in a fifth calibration step that is performed in particular prior to the first calibration step, the third acceleration signal being compared with the gravitational acceleration in a sixth calibration step for determining another calibration signal. Advantageously, the direction of the gravitational field relative to the orientation of the acceleration sensor (in particular relative to the third direction) is thus ascertained and is provided in the form of the additional calibration signal for further processing such that a rectification of the first and second acceleration signal with respect to acceleration components that are aligned in parallel to the gravitational field and thus do not contribute to the detection of the forward motion is made possible by the additional calibration signal. The coordinate system of the acceleration sensor may be virtually rotated in such a way that the calibrated third direction is aligned parallel to the gravitational field and the calibrated first and the calibrated second direction lie in a plane that is essentially perpendicular to the gravitational field. The coordinate system of the acceleration sensor may be additionally virtually rotated as a function of the calibration signal and the additional calibration signal in such a way that the calibrated first direction is aligned parallel to the forward direction and the calibrated third direction is aligned parallel to the gravitational field.

Another development provides for a first angular offset between the first direction and a forward direction of a user of the acceleration sensor to be determined in a seventh calibration step as a function of the calibration signal and/or of the additional calibration signal. By rotating the first direction by the first angular offset, in particular perpendicularly to the gravitational field, it is thus possible to ascertain the calibrated first direction, which is aligned in particular parallel to the forward direction. The first angular offset may comprise a numerical angle, a rotational vector and/or a three-dimensional rotational tensor. Using the first angular offset, it is thus possible to determine the forward component from the acceleration vector such that the forward speed or a step is extractible from the measured overall motion of the motion sensor.

Another subject matter of the exemplary embodiments and/or exemplary methods of the present invention is an operating method for a motion sensor, the motion sensor being calibrated in a first operating step, and a motion state and/or a step of a user of the motion sensor parallel to a forward direction being detected in a second operating step, the motion sensor being calibrated using the calibration method according to the present invention. This advantageously allows for a comparatively precise determination of the motion state or of a step of the user. Comparatively small and slow steps are thus also detectable. Moreover, in particular not only motion states such as jogging or walking are detectable, but because of the precise alignment of the acceleration sensor motion states of the user such as running, jumping, ambling, standing, sitting, lying, swimming, bicycling, gymnastics etc. are detectable as well. For this purpose, the alignment and the position of the acceleration sensor relative to the user is respectively determined during a step motion of the user, and the acceleration sensor is calibrated thereupon. This calibration is subsequently used for precisely detecting a subsequent motion state such as sitting for example. When performing a new step, for example when resuming the walking activity, the acceleration sensor may be calibrated anew.

A development provides for the first and the second operating step to be repeated sequentially, in particular the first operating step being performed prior to each second operating step. Advantageously, the acceleration sensor is thus continuously calibrated, whereby the accuracy is increased substantially compared to the related art. If the acceleration sensor shifts out of place in operation, this is detected automatically and does not result in an impairment of the measurement. Advantageously, this makes it possible for a patient to wear the acceleration sensor permanently for example. Particularly, the acceleration sensor may be recalibrated with every step.

Another development provides for the motion state and/or the step to be determined as a function of the first, second and/or third acceleration signal and as a function of the calibration signal and/or the additional calibration signal. Advantageously, the coordinate system of the motion sensor is rotated virtually in such a way as a function of the calibration signal in relation to the evaluation of the measured acceleration signals that the calibrated first direction is aligned parallel to the forward direction. In addition, the coordinate system of the motion sensor is rotated virtually as a function of the additional calibration signal in such a way that the calibrated third direction is aligned parallel to the gravitational field and also the calibrated first direction is aligned perpendicularly to the gravitational field. A motion state or a step of the user is thus detectable in a simple manner by analyzing the amplitude and/or the frequency of the first and/or second acceleration signal. The forward motion is thus to be evaluated in particular directly on the basis of the first acceleration signal measuring parallel to the calibrated first direction.

Another development provides for the first, second and/or third acceleration signal to be generated by an acceleration sensor and/or by a rotation-rate sensor so as to allow for a comparatively cost-effective and compact production of the acceleration sensor.

Another subject matter of the exemplary embodiments and/or exemplary methods of the present invention is a motion sensor, in particular a pedometer, the motion sensor being configured to measure a first acceleration signal as a function of an acceleration parallel to a first direction, the motion sensor being configured to measure a second acceleration signal as a function of an acceleration parallel to a second direction, wherein the motion sensor is configured to ascertain an acceleration vector from the angle between the first and the second acceleration signal in a third calibration step, the motion sensor being configured to determine a calibration signal from a phase angle between the acceleration vector and the first direction in a fourth calibration step. The motion sensor may be configured to implement the operating method according to the present invention.

Exemplary embodiments and/or exemplary methods of the present invention are illustrated in the drawing and explained in detail in the following description.

### BRIEF DESCRIPTION OF THE DRAWINGS

FIG. 1 shows a schematic view of a calibration method according to an exemplary specific embodiment of the present invention.

FIG. 2a shows a schematic view of an acceleration sensor according to an exemplary specific embodiment of the present invention.

FIG. 2b shows another schematic view of an acceleration sensor according to an exemplary specific embodiment of the present invention.

FIG. 3a shows a respective relationships between first, second and third acceleration signals of an acceleration sensor according to the exemplary specific embodiment of the present invention at different walking speeds of a user.

FIG. 3b shows a respective relationships between first, second and third acceleration signals of an acceleration sensor according to the exemplary specific embodiment of the present invention at different walking speeds of a user.

FIG. 3c shows a respective relationships between first, second and third acceleration signals of an acceleration sensor according to the exemplary specific embodiment of the present invention at different walking speeds of a user.

FIG. 3d shows a respective relationships between first, second and third acceleration signals of an acceleration sensor according to the exemplary specific embodiment of the present invention at different walking speeds of a user.

FIG. 4a shows first, second and third acceleration signals and the phase angle of an acceleration sensor according to the exemplary specific embodiment of the present invention at different positions relative to the user.

FIG. 4b shows first, second and third acceleration signals and the phase angle of an acceleration sensor according to the exemplary specific embodiment of the present invention at different positions relative to the user.

FIG. 4c shows first, second and third acceleration signals and the phase angle of an acceleration sensor according to the exemplary specific embodiment of the present invention at different positions relative to the user.

FIG. 5a shows first, second and third acceleration signals and the phase angle of an acceleration sensor according to the exemplary specific embodiment of the present invention at different walking speeds of a user and a specific position relative to the user.

FIG. 5b shows first, second and third acceleration signals and the phase angle of an acceleration sensor according to the exemplary specific embodiment of the present invention at different walking speeds of a user and a specific position relative to the user.

### DETAILED DESCRIPTION

In the various figures, identical parts are always denoted by the same reference symbols and are therefore usually labeled or mentioned only once.

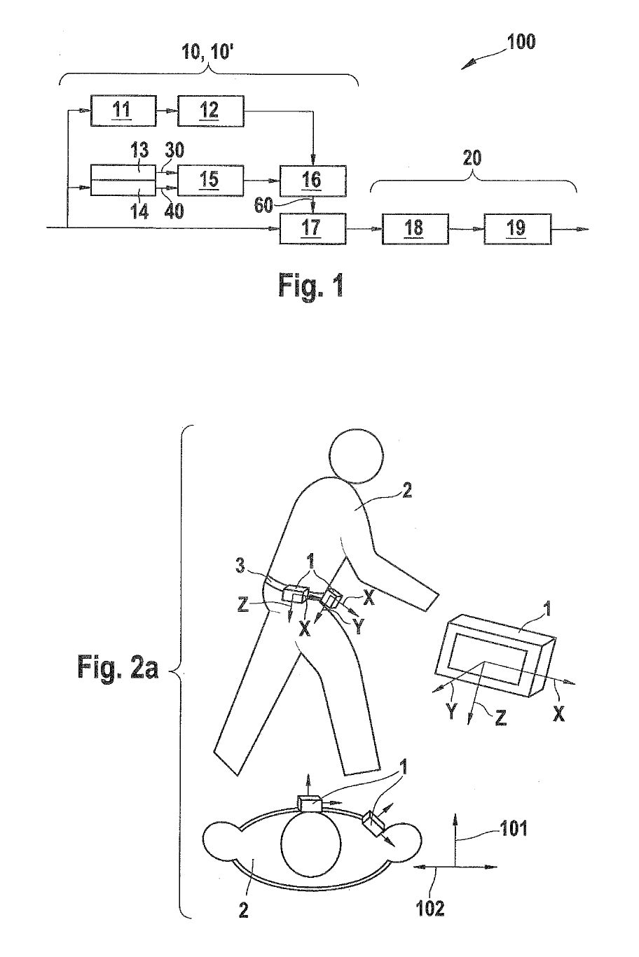

A schematic view of an operating method 100 according to an exemplary specific embodiment of the present invention is represented in FIG. 1, the figure showing a schematic flow chart while a user 2 is using acceleration sensor 1, in which a first operating step 10 and a second operating step 20 are performed in succession. First operating step 10 includes a fifth calibration step 11, in which a third acceleration signal 50 is measured parallel to a third direction Z. In a sixth calibration step 12, third acceleration signal 50 is compared to the gravitational acceleration, which is in particular 9.81 m/s², and an angle between the third direction Z and the gravitational field is determined from the comparison, which indicates the deviation between the third direction Z and the perpendicular parallel to the gravitational field.

Another calibration signal is produced as a function of this angle. Furthermore, during a movement of user 2, a first acceleration signal 30 is measured parallel to a first direction X in a first calibration step 13, first direction X being aligned perpendicular to third direction Z. In a second calibration step 14, again during the movement of user 2, a second acceleration signal 40 is measured parallel to a second direction Y, second direction Y being oriented perpendicular both to first direction X as well as to third direction Z. First, second and third acceleration signals 30, 40, 50 may be measured independently of each other by an appropriately oriented triaxial acceleration sensor of motion sensor 1. In a third calibration step 15, an acceleration vector is ascertained as a function of the first and the second acceleration signal 30, 40. A vector addition of the first and the second acceleration signal 30, 40 may be performed for this purpose.

The hip movement of user 2 while walking entails that a phase angle 60 between the direction of the acceleration vector and first direction X over time fluctuates continually around an essentially constant average value. The angle of this average value depends directly on the position of acceleration sensor 1 relative to the user and thus relative to the user's forward motion 101. In a subsequent fourth calibration step 16, this average value of phase angle 60 is therefore determined and, if necessary, may be compared with a reference value stored in a lookup table such that the orientation of motion sensor 1 is determinable in a plane perpendicular to the gravitational field and relative to forward motion 101 of user 2. The deviation or the angle between the forward motion of user 2 parallel to forward direction 101 and first direction X is output as the calibration signal and may correspond exactly to the average value of phase angle 60.

In the subsequent seventh calibration step 17, acceleration sensor 1 is calibrated as a function of the calibration signal and the additional calibration signal. For this purpose, the coordinate system of acceleration sensor 1 of first, second and third direction X, Y, Z is virtually rotated in such a way that a calibrated first direction X′ is aligned parallel to forward direction 101 and a calibrated third direction Z′ is aligned parallel to the gravitational field. In a subsequent first substep 18 of second operating step 20, the motion state or the step of user 2 is thus to be evaluated directly from first acceleration signal 30, which now measures the acceleration parallel to the calibrated first motion X′, particularly the frequency of first acceleration signal 30 being analyzed in order to determine a specific motion pattern. Alternatively, an evaluation of the second and/or third acceleration signal 40, 50 is conceivable in order to determine the forward motion or the step. In a second substep 19 of second operating step 20, a motion sensor is increased by one as soon as a step of user 2 is detected. Subsequently, the method may start again with first operating step 10.

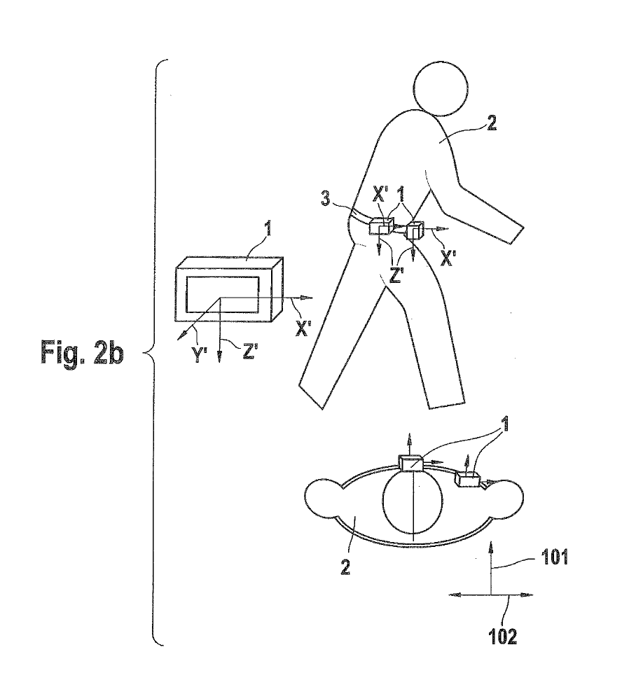

FIGS. 2a and 2b show schematic views of a motion sensor 1 according to an exemplary specific embodiment of the present invention, motion sensor 1 in FIG. 2a being fastened in any desired position and orientation on belt 3 of user 2. A first acceleration sensor 1 is represented in a first exemplary position in the area of a belt buckle of a belt 3 of the user, while a second acceleration sensor 1 is represented in a second exemplary position in the area of belt 3. In the first exemplary position, first direction X has a first angular offset, in particular a phase angle, from zero to forward motion 101, while in the second exemplary position the first angular offset, in particular the phase angle, is approximately 60 degrees. While user 2 moves by a step in forward direction 101, the triaxial acceleration sensors respectively implemented in acceleration sensors 1 measure the first, second and third acceleration signal 30, 40, 50 in the first, second and fifth calibration step 13, 14, 11.

Following the determination of the respective calibration signal and the respective additional calibration signal using the third, fourth and sixth calibration step 15, 16, 12, acceleration sensors 1 are calibrated in seventh calibration step 17, the coordinate systems of acceleration sensors 1, if necessary, being virtually rotated as a function of the calibration signal and the additional calibration signal as shown in FIG. 2b in such a way that the calibrated third direction Z′ is respectively oriented parallel to the gravitational field and the calibrated first direction X′ is respectively oriented parallel to forward direction 101.

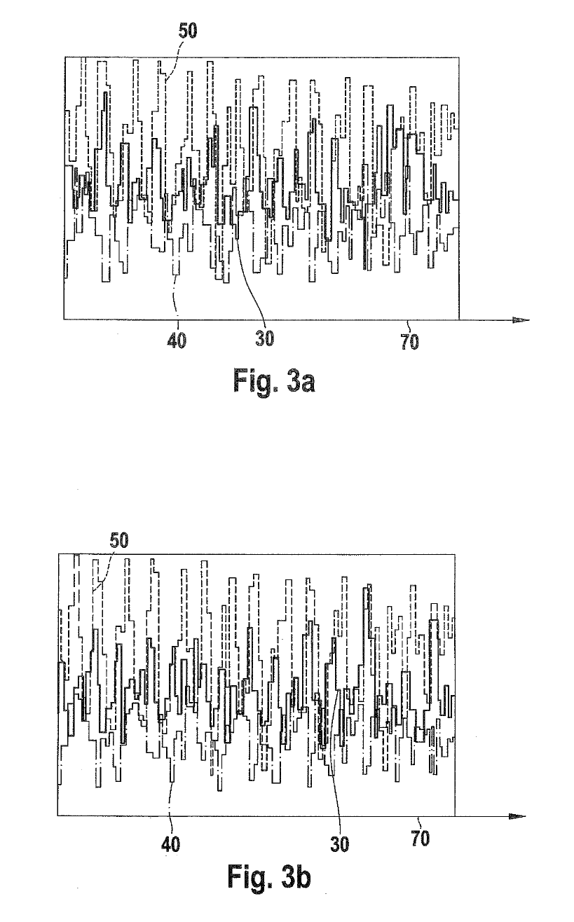

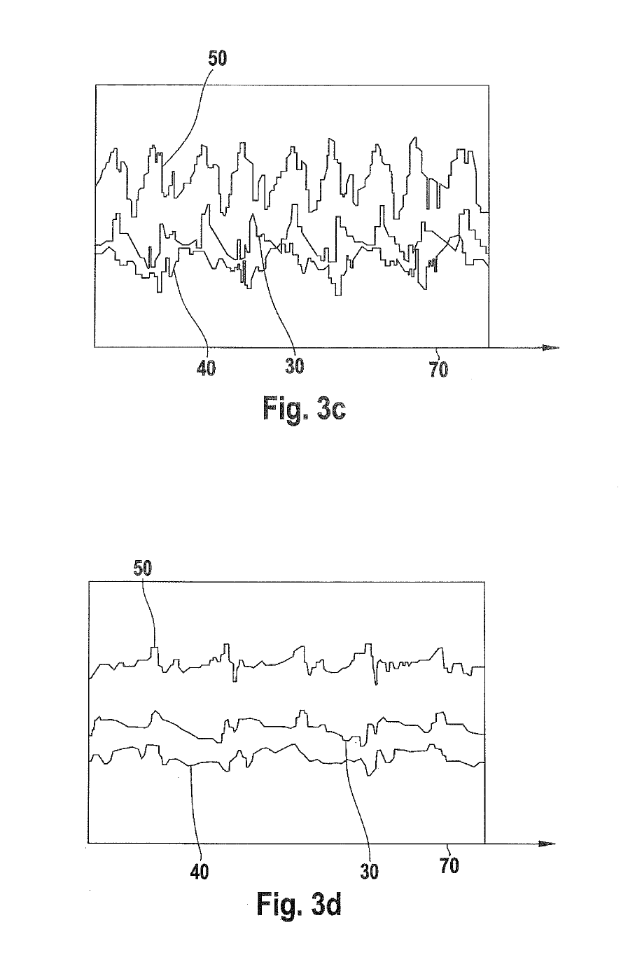

FIGS. 3a through 3d respectively show the relationships between first, second and third acceleration signals 30, 40, 50 of a motion sensor 1 according to the exemplary specific embodiment of the present invention at different walking speeds of a user 2, respectively the first, second and third acceleration signal 30, 40, 50 being plotted over time 70. FIG. 3a shows the time-dependent first, second and third acceleration signal 30, 40, 50 while user 2 is running, FIG. 3b shows these while user 2 is walking quickly, FIG. 3c shows these while user 2 is walking slowly, and FIG. 3d shows these while user 2 is shuffling. It can be seen that both the amplitudes of acceleration signals 30, 40, 50 as well as the frequencies diminish with decreased forward speed.

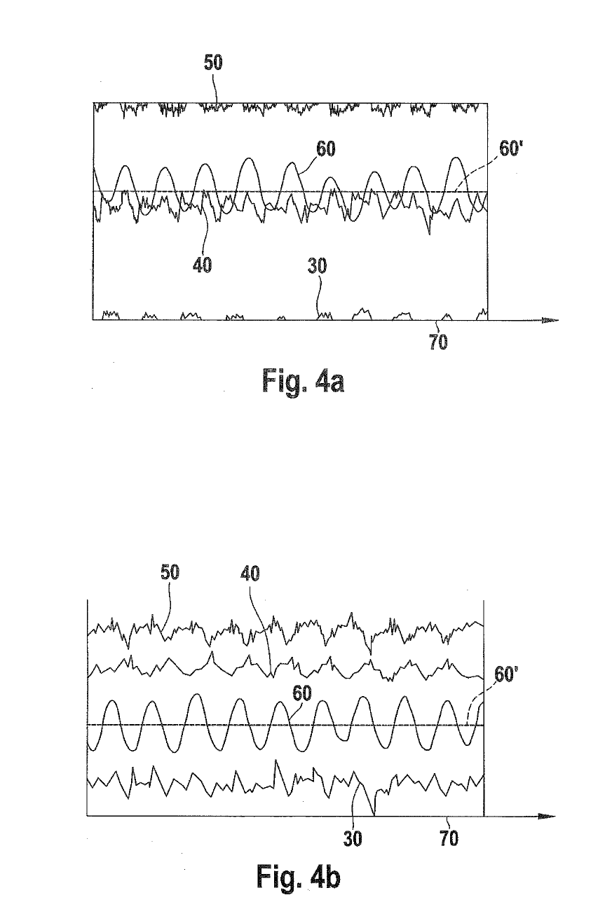

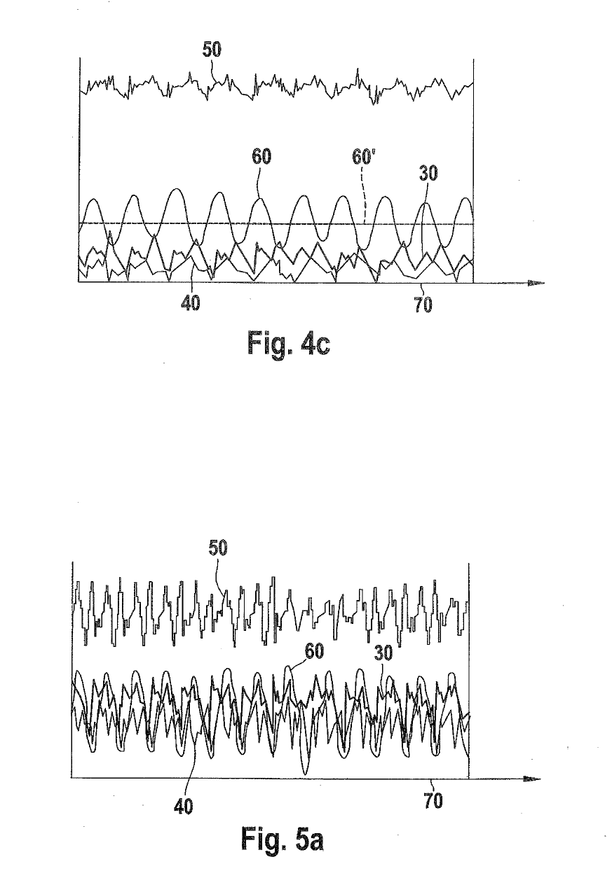

FIGS. 4a, 4c and 4b respectively show first, second and third acceleration signals 30, 40, 50 of an acceleration sensor 1 according to an exemplary specific embodiment of the present invention in different positions relative to user 2. In all three figures, acceleration sensor 1 is fastened on belt 3 of user 2, acceleration sensor 1 being situated relative to forward motion 101 of user 2 on the left in FIG. 4a, on the left in front in FIG. 4b and on the right in front in FIG. 4c. FIGS. 4a, 4b and 4c moreover illustrate the respective change in phase angle 60 over time. It can be seen that the average value 60′ of the phase angle is constant over time and depends merely on the position of acceleration sensor 1 relative to forward direction 101 in the X-Y plane. From the average value of the phase angle it is thus possible to determine the position of acceleration sensor 1 on belt 3 directly such that it is possible to calibrate acceleration sensor 1 automatically.

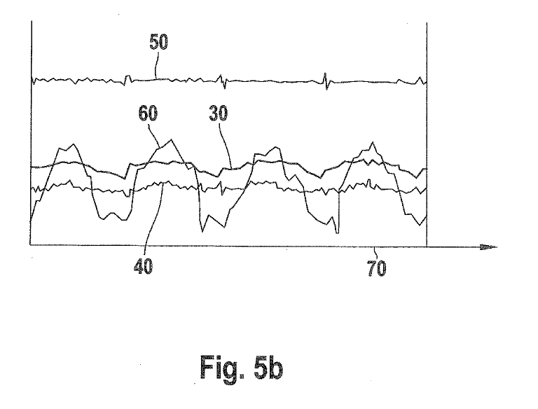

FIGS. 5a and 5b each show first, second and third acceleration signals 30, 40, 50 of an acceleration sensor 1 according to the exemplary specific embodiment of the present invention at different walking speeds of a user 2, acceleration sensor 1 in both FIGS. 5a and 5b being fastened in the same position relative to user 2. It can be seen that in spite of the different walking speeds, which are approximately 0.85 steps per second in FIG. 5a and approximately 0.25 steps per second in FIG. 5b, the average value of phase angle 60 is nearly constant such that it becomes possible to determine the position and the orientation of acceleration sensor 1 independently of the speed.

What is claimed is:

1. A calibration method for a motion sensor, the method comprising:
in a first calibration task, measuring a first acceleration signal as a function of an acceleration parallel to a first direction;
in a second calibration task, measuring a second acceleration signal as a function of an acceleration parallel to a second direction;
in a third calibration task, ascertaining an acceleration vector from an angle between the first acceleration signal and the second acceleration signal; and
in a fourth calibration task for determining a calibration signal, determining a phase angle between the acceleration vector and the first direction.

2. The calibration method of claim 1, wherein an average value of the phase angle over time is determined in the fourth calibration task for determining the calibration signal.

3. The calibration method of claim 1, wherein a constant component in the phase angle is determined in the fourth calibration task and is removed by using a high-pass filter.

4. The calibration method of claim 1, wherein a third acceleration signal is measured as a function of an acceleration parallel to a third direction in a fifth calibration task that is performed prior to the first calibration task, the third acceleration signal being compared to the gravitational acceleration in a subsequent sixth calibration task for determining another calibration signal.

5. The calibration method of claim 1, wherein a first angular offset between the first direction and a forward direction of a user of the motion sensor is determined in a seventh calibration task as a function of at least one of the calibration signal and the additional calibration signal.

6. An operating method for a motion sensor, the method comprising:
in a first operation, calibrating the motion sensor by performing the following:
in a first calibration task, measuring a first acceleration signal as a function of an acceleration parallel to a first direction,
in a second calibration task, measuring a second acceleration signal as a function of an acceleration parallel to a second direction,
in a third calibration task, ascertaining an acceleration vector from an angle between the first acceleration signal and the second acceleration signal, and
in a fourth calibration task for determining a calibration signal, determining a phase angle between the acceleration vector and the first direction; and
in a second operation, detecting at least one of a motion state and a step of a user of the motion sensor that is parallel to a forward direction.

7. The operating method of claim 6, wherein the first operating task and the second operating task are repeated sequentially, and wherein the first operating step task is performed prior to each second operating task.

8. The operating method of claim 6, wherein at least one of the motion state and the task are determined as a function of at least one of the first acceleration signal, the second acceleration signal, and the third acceleration signal, and as a function of at least one of the calibration signal and the additional calibration signal.

9. The operating method of claim 6, wherein the first acceleration signal, the second acceleration signal, and the third acceleration signal are generated by at least one of an acceleration sensor and a rotation-rate sensor.

10. A motion sensor, comprising:
a motion sensor arrangement having an acceleration sensor configured for measuring a first acceleration signal as a function of an acceleration parallel to a first direction and for measuring a second acceleration signal as a function of an acceleration parallel to a second direction;
wherein the acceleration sensor is configured for ascertaining an acceleration vector from an angle between the first acceleration signal and the second acceleration signal in a third calibration task;
wherein the motion sensor is configured for determining a calibration signal from a phase angle between an acceleration vector and a first direction in a fourth calibration task.

12. The motion sensor of claim 10, wherein the motion sensor includes a pedometer.

12. The calibration method of claim 1, wherein the motion sensor includes a pedometer.

13. The operation method of claim 6, wherein the motion sensor includes a pedometer.
